(19) United States
(12) Patent Application Publication
(10) Pub. No.: US 2002/0157023 A1
(43) Pub. Date: Oct. 24, 2002

(54) Layering enterprise application services using semantic firewalls

(76) Inventors: John R. Callahan, Columbia, MD (US); David P. Glock, Westminster, MD (US)

Correspondence Address: VENABLE, BAETJER, HOWARD AND CIVILETTI, LLP, P.O. BOX 34385, WASHINGTON, DC, 20043-9998, US

(21) Appl. No.: 10/107,302

(22) Filed: Mar. 28, 2002

Related U.S. Application Data
(60) Provisional application No. 60/279,410, filed on Mar. 29, 2001.

(51) Int. Cl. H04L 9/00

(52) U.S. Cl. 713/201

(57) ABSTRACT

A system for processing data requests from clients via a network is disclosed. The system has an application server coupled to a network, and a semantic firewall to pass and filter the content between the application server and the clients. The application server provides content from a database to the clients via the network, and the semantic firewall restricts access to a portion of the content for one or more clients.

### CROSS-REFERENCE TO RELATED APPLICATION

The present application is related to U.S. Provisional Patent Application No. 60/279,410, filed Mar. 29, 2001 entitled “Layering Enterprise Application Services Using Semantic Firewalls” to David P. Glock et al., the contents of which are incorporated herein by reference in their entirety.

### BACKGROUND OF THE INVENTION

1. Field of the Invention

The present invention relates generally to secure and efficient computer network transactions, and more particularly to fireballs.

2. Related Art

Many companies use extensible markup language (XML) dialects to encode their e-business information models but fail to consider the information assurance aspects of their business processes in these models. Usually, information assurance is considered an afterthought once the basic enterprise information model is complete. In many cases, enterprise applications must be rewritten in order to incorporate security, privacy, and integrity checks that are outside the scope of the information model but entwined in the business process itself. Changing information models and security policies exacerbate the problem by forcing designers to develop complex, intertwined solutions that are not scalable and are difficult to configure.

Currently virtual private networks (VPN), site management solutions, encryption, and packet firewalls are used to relieve application programs from the burden of handling session management concerns. Most application programs, however, are not concerned with whether or not a specific internet protocol (IP) address is disallowed, or a user is barred from login, or only certain users can invoke a common gateway interface (CGI) script or not. Indeed, these issues are typically handled using external configuration files and other programs that can be dynamically reconfigured without service interruptions. Most of these configuration files and support programs can be managed by non-programmers with standard training and certification. However, using external configuration files is problematic because they are typically limited to simple parameter name and values that cannot be used to specify complex rules and constraints.

IP firewalls and site management tools provide raw access control to uniform resource locators (URLs), files, and directories, but role-based access control (RBAC) and task-based access control (TBAC) are difficult to integrate into enterprise information models. Current 4 packet-based and file-based access control models are not powerful enough to manage access decisions that depend on the data itself and the role of the person(s) viewing and changing the data.

For example, FIG. 1 depicts a conventional enterprise information model 100 as a set of extensible markup language (XML)-based enterprise applications 102a, 102b , and 102c (generally 102), such as, e.g., Java servlets, that combine data-dependent access control with the enterprise business logic. Each enterprise application 102 must decide on its own what data to access, for example from a secure database 106, which clients 108a, 108b, and 108c have access to specific data, and at what times the data is valid and accessible. The server 104 must in turn trust the resident applications 102 to obey the security, privacy, and integrity policies set forth in the business practices of the organization. As one problem with this prior art approach, an errant application could produce views or allow edits of sensitive data that violate corporate access policies and standards.

FIG. 2 depicts an alternate conventional solution to the system of FIG. 1, where the enterprise server 104 may use a security manager thread 202 to mediate all requests for information and manage access control between the applications 102. The disadvantage of this arrangement is that the security manager must be an integral part of the system design, not an afterthought, and must be a basic component of the object model of the system. Furthermore, management of information and assurance policies must be implemented directly in computer source code to be effective. These policies cannot be easily changed outside the system by administrative personnel due to the data-dependent characteristics.

The security manager model of FIG. 2 can be an effective approach for e-business systems whose information assurance models are well established. But many business models are still undergoing rapid evolution. Major sectors of the new e-business economy continue to struggle with complex access control decisions that are data-dependent.

Healthcare and financial institutions, for example, cannot afford to use monolithic enterprise solutions that tie the institution to one solution, because changing priorities and budgets force the institution to seek outsourced services in competitive markets, such as, e.g., application service providers (ASP). Thus, the institutions must rely on open standards to quickly integrate new providers, new partners, and new services. However, such standards currently do not address information assurance problems, and those institutions must continue to rely on costly stove-pipe information technology (IT) solutions.

Several projects and a few commercial products exist to filter web content between an application server and a user agent browser. Most of these tools are focused on either hypertext markup language (HTML) filtering or wireless application protocol (WAP) transformations. Many of the transformation engines operate as web proxies at the client end to enable personalization, privacy, ad filtering, or other user agent functions. Only IBM's Transcoding Sphere solution begins to address XML-based content filtering, but mostly for HTML to WAP transformations.

Lutris' Enhydra XML/Java application server provides capabilities to build enterprise applications that can accept and produce XML as input and output respectively. The XMLC tool of Lutris converts XML files into Java objects (by compiling the XML into a set of JAXP invocations to create a document object model (DOM) tree). This conversion allows XML site developers to build a programmable web publishing platform in XML and Java. The Enhydra Project is documented at http://www.enhydra.org/.

The Apache Cocoon project has a similar architecture for enabling XML-based web publishing. The Apache Jakarta project has a subproject called Struts that takes a blackboard approach to simplifying the monolithic architecture of most web application servers like J2EE, WebLogic, and BizTalk servers. This subproject strives to solve the problems of monolithic web application server architectures through a simplified architectural pattern, but does not provide the separation of filtering concerns and a rule-based approach.

Intel's Redirector tool is an XML-based content filter that redirects whole XML content to web load management servers by determining content types and XML tags. Redirector does not employ XML schema to make its decisions, but instead employs tag-level decision making to re-route server output only.

The Muffin Web Proxy, http://muffin.doit.org/, FilterProxy, http://filterproxy.sourceforge.net, and IBM's Web Intermediaries Project (WBI), http://www.almaden.ibm.com/cs/wbi, (the research tool on which the Transcoding Sphere is based) are initial attempts to place content filtering in a web proxy. The WBI tool has a demonstration XSLT transformation example, but deals only with fixed style sheet transformations based on style sheet processing instructions embedded in the XML content itself.

The prototype semantic firewall is implemented as a filter plug-in in both Muffin and WBI.

Site management tools from companies like Netegrity and Oblix tend to focus solely on URL, directory, and file-based access control to web sites and do not address content filtering issues. While such filtering is essential to complete web security, this filtering is not adequate to cover the growing concern for filtering content for authenticated users.

What is needed is an efficient, scalable, easy-to-configure, secure, private way to manage and assure network transactions via analysis of the contents of the data stream itself between client and server.

### SUMMARY OF THE INVENTION

In an exemplary embodiment of the present invention a system, method and computer program product for layering enterprise application services using semantic firewalls is disclosed.

In one exemplary embodiment, the present invention can be a system for processing data requests from clients via a network, having an application server coupled to a network, the application server providing content from a database to the clients via the network; and a semantic firewall to pass and filter the content between the application server and the clients, the semantic firewall restricting access to a portion of the content for at least one client.

In a second exemplary embodiment, the present invention can be a method of processing a data request by a server, comprising the steps of receiving a data request from a client via a network; retrieving requested data from a database; annotating the requested data to obtain annotated data; filtering the annotated data to obtain filtered data; rendering the filtered data to obtain rendered data; and providing the rendered data to the client via the network.

Further features and advantages of the invention, as well as the structure and operation of various embodiments of the invention, are described in detail below with reference to the accompanying drawings.

### Definitions

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left-most digits in the corresponding reference number indicate the drawing in which an element first appears.

FIG. 1 depicts a conventional approach to network transaction and security management;

FIG. 2 depicts another conventional approach to network transaction and security management;

FIG. 3 depicts an exemplary embodiment of a system for network transaction and security management according to the present invention;

FIG. 4 shows a second exemplary embodiment of a system for network transaction and security management according to the present invention;

FIG. 5 depicts an exemplary embodiment of a semantic firewall according to the present invention;

FIG. 6 depicts an exemplary embodiment of the first stage of annotation according to the present invention;

FIG. 7 depicts an exemplary embodiment of the second stage of filtering according to the present invention;

FIG. 8 depicts an exemplary embodiment of the third stage of rendering HTML according to the present invention;

FIG. 9 depicts an exemplary embodiment of an XML record according to the present invention;

FIG. 10 depicts an exemplary embodiment of the output of a rule-based transformation according to the present invention;

FIG. 11 depicts an exemplary embodiment of raw semantic firewall rules according to the present invention;

FIG. 12 depicts an exemplary embodiment of an HTML form page for modifying rules according to the present invention;

FIG. 13 depicts an exemplary embodiment of an XML style sheet according to the present invention;

FIG. 14 depicts an exemplary embodiment of a final XML output file after the application of an XML style sheet according to the present invention;

FIG. 15 depicts an exemplary embodiment of a browser view of a transformed XML file according to the present invention;

FIG. 16 depicts an exemplary query result in XML according to the present invention;

FIG. 17 depicts the result of a record transformation according to the present invention;

FIG. 18 depicts an annotated XML file according to the present invention;

FIG. 19 depicts an exemplary style sheet according to the present invention;

FIG. 20 depicts an exemplary XHTML output of a filtering process of the present invention; and

FIG. 21 depicts an exemplary embodiment of a filter chain according to the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

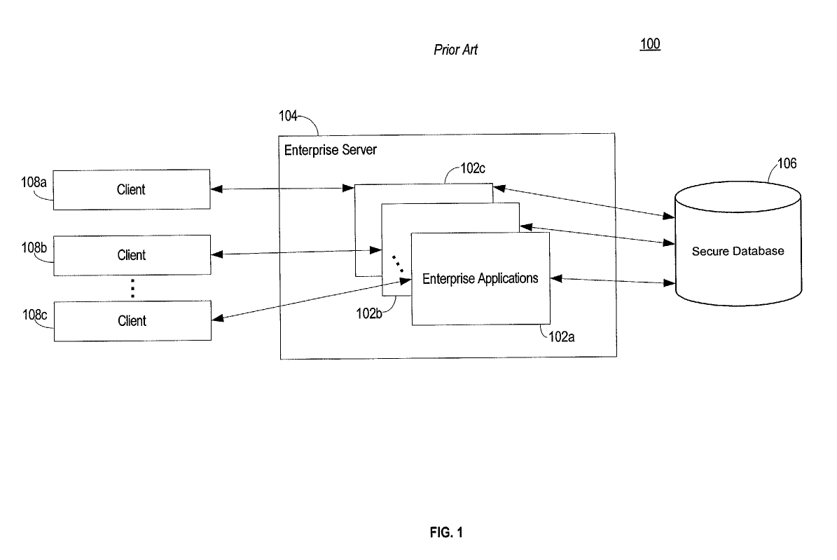

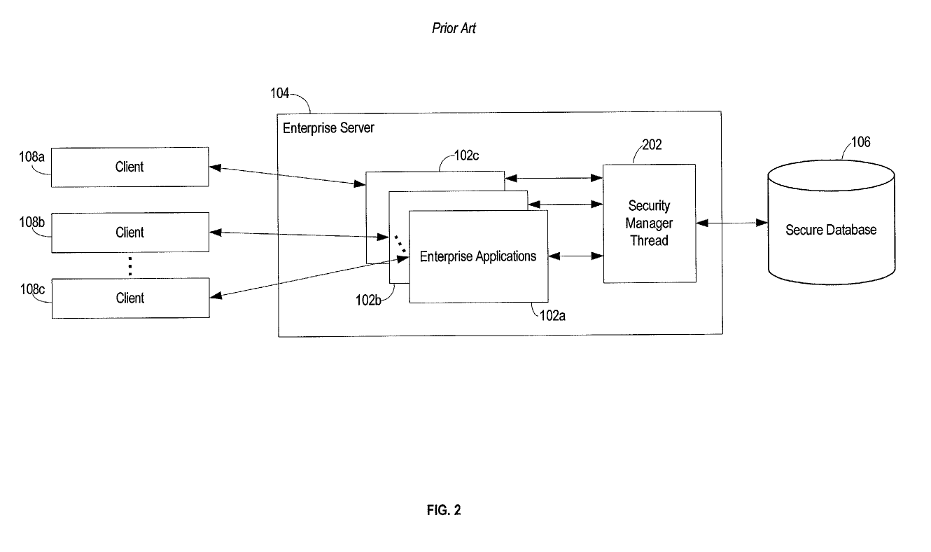

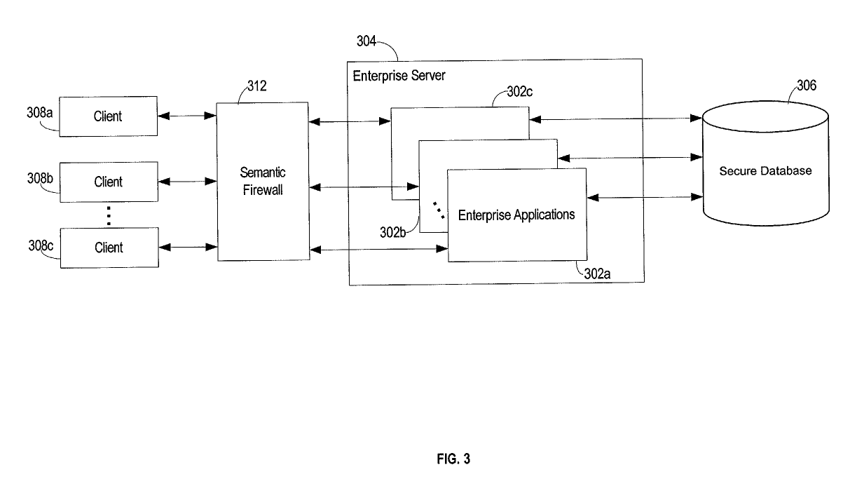

FIG. 3 depicts an exemplary embodiment of a system for network transaction and security management according to the present invention. A semantic firewall 312, which can be, for example, an XML-based filter, lies outside the core enterprise applications 302a, 302b, and 302c (generally 302). The semantic firewall 312 acts as a layer between requests for data from clients 308a, 308b, and 308c (generally 308) and the enterprise server 304. The clients 308 no longer interact directly with the enterprise applications 302 as in the conventional approaches illustrated in FIGS. 1 and 2. Instead, the semantic firewall 312 receives client requests and transforms the requests to forms that are appropriate for the role and level of access of the client. The transformed forms are then given to the applications 302, which no longer need to be responsible for security or data accessibility restrictions. Similarly, data retrieved by an enterprise application 302 from a secure database 306 is passed through the semantic firewall 312 to the clients 308, rather than directly to the clients from the application as in the conventional approach. This approach allows the semantic firewall to limit the access a client has to data without having to rely on the application to limit the access. Within the semantic firewall layer there may be additional “layers” of sub-filters that perform sub-tasks within the filtering process. For example, one filter may attach personalization information while the next filter uses personalization information and the XML data stream to internationalize the content.

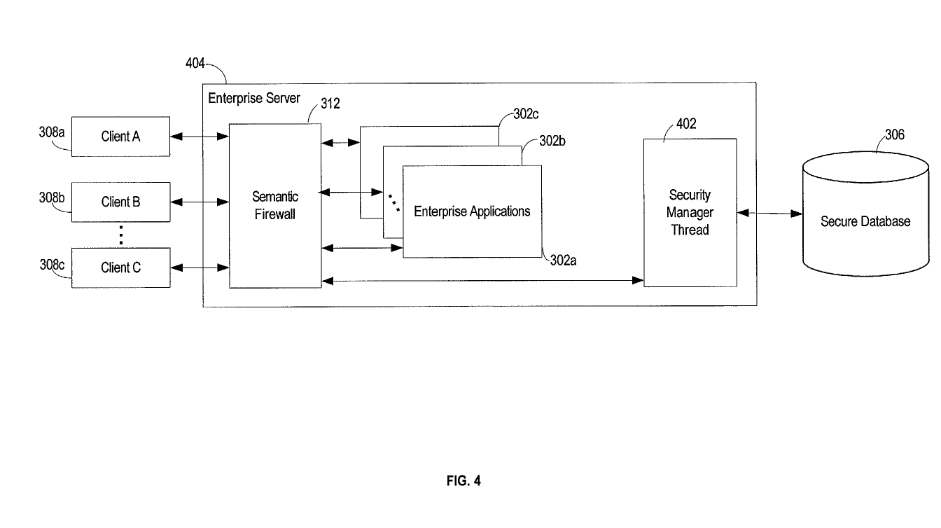

FIG. 4 shows a second exemplary embodiment of a system for network transaction and security management according to the present invention. In FIG. 4, the semantic firewall 312 lies within the enterprise application sever 404, but only to share server resources such as, for example, the CPU, files, and communication channels. The semantic firewall 312 of FIG. 4 can be the same as semantic firewall 312 in FIG. 3. The semantic firewall 312 of FIG. 4 can also run on the same machine as the application server. The semantic firewall 312 can also work in conjunction with the existing security manager 402.

In either embodiment of FIG. 3 or FIG. 4, the semantic firewall 312 can also work with the enterprise application server 304 or 404, respectively, to provide highly re-configurable, scalable, data-specific, role-based, and task-dependent access management. The semantic firewall 312 can be based on software that allows customized, automated form-fill for HTML-based forms. The software can be deployed as an intranet or extranet application service, or as an Internet consumer service. The semantic firewall software allows for login-based access control of information used to fill out web-based forms. Form-fill can be viewed as a “filtering” action on the profile information of a person, which can be stored in the secure database 306. For example, the history of form-fill actions for a user can be stored in the database. A query for current information to be used to fill out the form is performed and returned to the application in use by the client. The semantic firewall can check the integrity of the information regarding profiles, frequency of use, inter-field dependency, and other policy level filtering, encryption, and encodings that are somewhat independent of the profile information of the client.

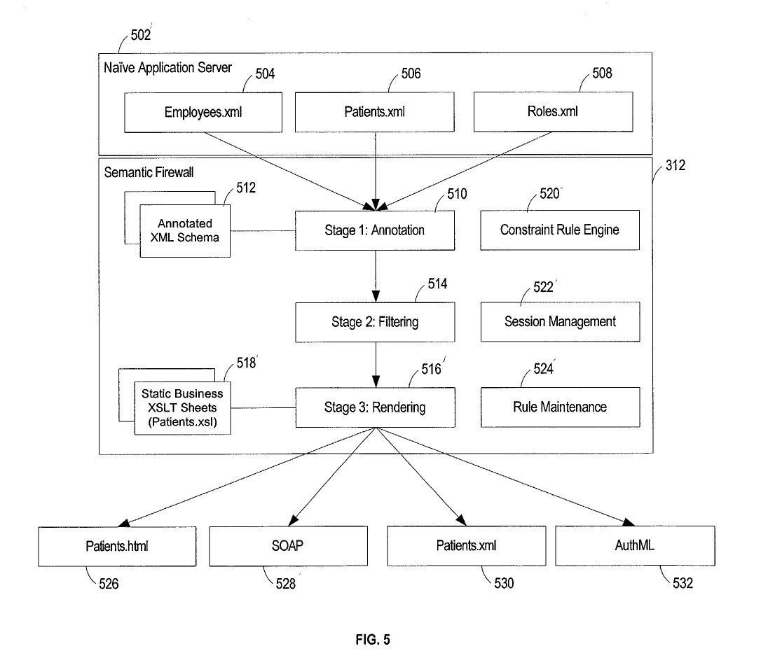

FIG. 5 depicts an exemplary embodiment of a semantic firewall 312 according to the present invention as illustrated in FIG. 3. Raw XML content is aggregated from the backend systems known as a naive application server (NAS) 502. NAS 502 can also be an enterprise application server 304. The aggregation of raw XML content can be the result of a query from the client, which might be executed in SQL. The NAS 502 interacts directly with the data repositories such as, e.g., databases, document archives, legacy systems, or secure databases 306, which can return the query result, for example, as an XML fragment. The NAS 502 is said to be “naive” because it is concerned only with the core business logic that processes raw repository requests such as database inserts, updates, selects, and document searches.

The semantic firewall 312 can be built on open, XML-based standards that allow any enterprise to focus on their core business logic and data modeling tasks and allows enterprise managers to separate information assurance concerns outside the core business logic. The semantic firewall allows managers to control the security aspects in an easily configurable firewall outside the core system. The semantic firewall application program interface (API) can be configured with enterprise servers such as, e.g., J2EE, WebLogic, WebSphere, and Enhydra, to pre-process and post-process XML content via a simple API for XML (SAX)-based API.

The semantic firewall 312 performs a series of filtering operations on, for example, XML content, between the client and server using extensible style language transformations (XSLT) that are dynamically generated by a policy constraint rule engine 520. Annotated XML schema 512 are used to define the syntax for the XML content, and constraint rules are used to perform semantic transformations on the XML content that can add, delete, censor, encrypt, and decrypt field contents. The semantic firewall 312 can also be configured to log, audit, trace, and augment content to and from the client and server. The semantic firewall relies on standards such as, for example, SAML (Security Assertion Markup Language), XML-Sig (XML Digital Signature standard), and XML-Encryption to perform this filtering.

The constraint rules in the constraint rule engine 520 are used to generate dynamic XSLT style sheets (not shown) that are used to enforce role-based and task-based access control rules that are expressed in XML-based policy rules. These policy rules (called XRules) can be expressed at high-semantic levels relative to the schema constructs. By treating XSLT style sheets as the “assembly code” of the transform process, a semantic firewall is easily reconfigurable across a wide variety of XML Schema types. This relieves the XML portal manager from authoring and managing a large number of XSLT files.

The constraint-based approach of the invention allows the semantic firewall to be easily configured by system administration and management personnel and reviewed by security policy experts. The semantic firewall can be configured, and reconfigured, for many e-business models, including, for example, healthcare and financial institutions, to express complex, data-specific, role-based, and workflow-dependent access rules. Industry-wide security standards and governmental laws can be based on such standards as they evolve with the core business models as well.

The semantic firewall 312 can be configured to add, delete, or transform, for example, XML content, to and from the NAS 502. The semantic firewall can be configured to perform multi-stage XML and HTML transformations as a server-based HTTP proxy. In an exemplary embodiment, the transformation can take place in three stages.

Prior to the first stage 510, the semantic firewall 312 can aggregate content from the NAS 502 which can produce, for example, various XML files 504, 506, and 508. In the first stage 510, the semantic firewall can annotate the XML with new attributes using annotated XML schema 512. In the second stage 514, the semantic firewall can filter the output of the first stage based on the attributes added during annotation. Finally, in the third stage 516, the semantic firewall can apply a dynamically generated XSLT transformation from static business XSLT style sheets 518 to render filtered XML or HTML content. Output from the transformations can include, for example, one or more files, such as an HTML file 526, a simple object access protocol (SOAP) message 528, an XML file 530, or an AuthML file 532 containing an encrypted message. FIG. 5 shows an XML response from server to client as the result of a request, but the request (an XML message) can also be filtered on its way from client to server. The request, for example, an HTTP request for a URL, can select resources, store a file, or initiate a query.

The annotations and transformations are generated by high-level rules. For example, using a CLIPS-like, forward and backward chaining expert system engine, organizational policies can be mapped to XML transformations. These rules are expressed as expert system rules, and the transformation is managed by syntax-directed translations relative to the XML Schema for the XML content.

The semantic firewall 312 can also have a session management module 522 that can retain state information between subsequent requests and/or responses. For example, shopping online is implemented as a series of page requests and responses. The “shopping basket” is the “state” maintained between page requests, that allows the server to reason about in which step of the process the user is currently located. The semantic firewall can also have a rule maintenance module 524 that provides an interface to modify the rules.

In an alternative embodiment, the XSLT style sheet itself is not rendered as a serialized stream, but rather as a transform object, i.e., a series of templates that represent SAX event handlers.

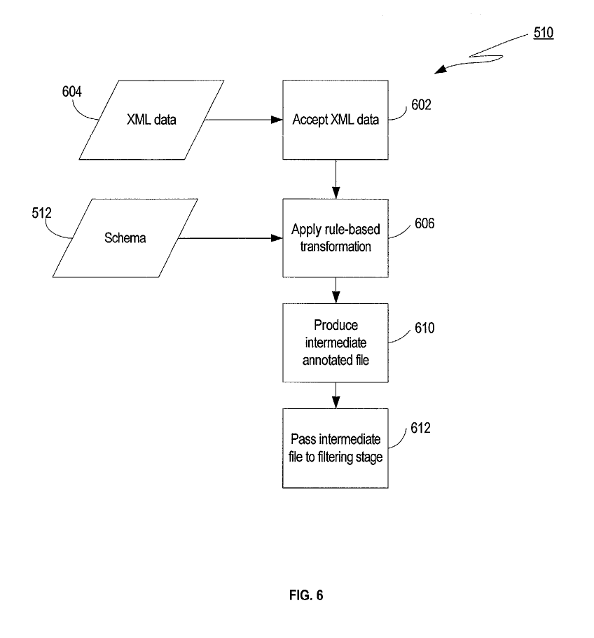

FIG. 6 depicts an exemplary embodiment of the first stage 510 of annotation for the semantic firewall. First, in block 602, the semantic firewall accepts the raw XML data 604 from the NAS 502, for example, in the form of files 504, 506, and 508. Next, in block 606, the annotated XML schema 512 are applied to the XML data from block 604. The XML schema 512 are annotated with semantic actions that direct the transformation process. These semantic actions generate XSLT in much the same way that a compiler produces machine or byte code, but the production is contextually dependent (in most cases) on the input XML data itself. The XML content dictates, via a DOCTYPE directive or XML namespace attribute, the XML schema or document type definition (DTD) 512 to be used for the transformation generating process, and parameterizes the generated XSLT style-sheets. The XML schema annotations are parsing actions that are implemented as an extension namespace and can also be used to generate facts in an expert system engine, interface with document search engines, and other filtering engines. The application of the annotated XML schema changes the XML file 504, 506 or 508 to an annotated intermediate file containing more attributes in block 610. The intermediate file is then passed to the second stage of filtering in block 612.

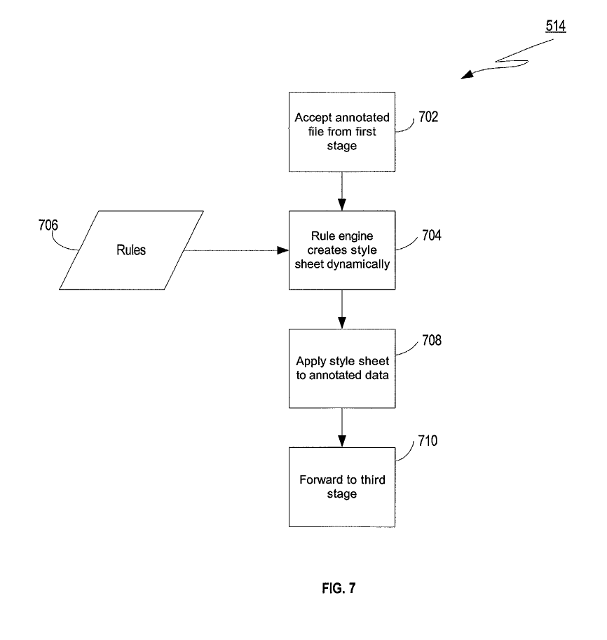

FIG. 7 depicts an exemplary embodiment of the second stage of filtering 514 for the semantic firewall 312. After the annotated file is accepted from the first stage in step 702, the rules engine dynamically generates a style sheet in block 704, using the rules 706. The style sheet is then applied to the annotated file in block 708. The fields in the annotated file are filtered when the style sheet removes or hides the fields that the user or client should not see. The filtered file is then passed to the third stage of rendering in block 710.

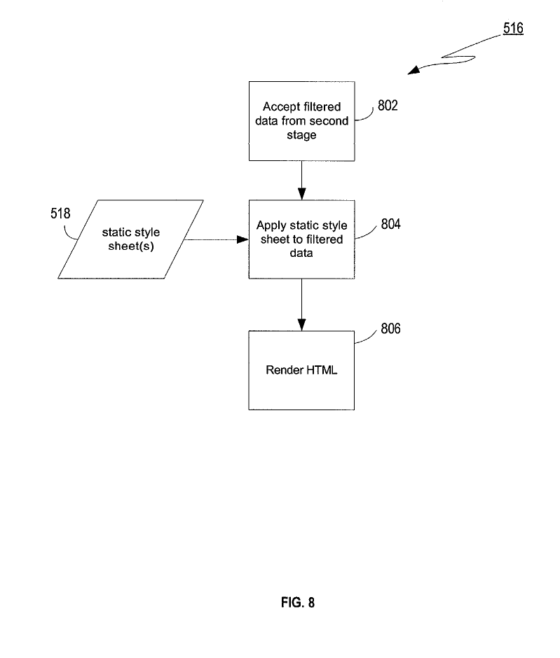

FIG. 8 depicts an exemplary embodiment of the third stage 516 of rendering transformed XML output according to the present invention. After accepting the filtered file in block 802, the fields in the filtered file are formatted according to static style sheets 518 in block 804. The application of the static style sheets can result, for example, in an HTML file, which is generated based on the style sheets and the data in block 806 and passed to the client.

For an exemplary embodiment employing a semantic firewall, consider a medical application server provider (ASP) servicing insurance claims over the Internet. The medical ASP must provide secure access to patient records for hospitals, physician offices, pharmacies, and claims agents. Each user must authenticate a session with the ASP system using a single sign-in login and password. The medical ASP system uses HTML-based forms to grant the user access to patient information based on the role of the user. The user may be able to view, change, or add information based on their role, the current status of a task, the sensitivity of the data itself, or a combination of factors. The application server must store and retrieve medical records to and from a database or collection of databases. Many of these databases may be from legacy systems. The application server must also manage session information; determine role permissions, task status, and graphical user interface (GUI) issues. Changing data permissions within the application logic can be a complex task. Policy changes often imply vast architectural changes that can overburden small organizations.

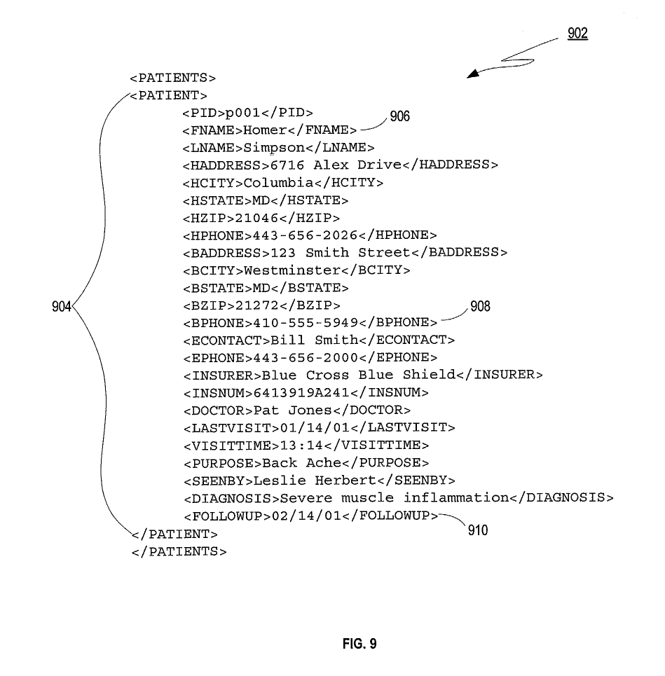

FIG. 9 depicts an exemplary output file 902, patients.xml, from a query for all patients for a particular physician, Dr. Pat Jones here. The partial record for a single patient is shown as a single XML-based patient record 904 within a list of patients. Within the record, there can be one or more fields, for example, first name field 906, business phone number field 908 and follow-up visit date 910. In this example, the current user is a receptionist within the medical claims provider and is permitted to view only a limited set of fields in the patient record. The receptionist is allowed to view only non-billing information and is able to edit only the date of a follow-up visit.

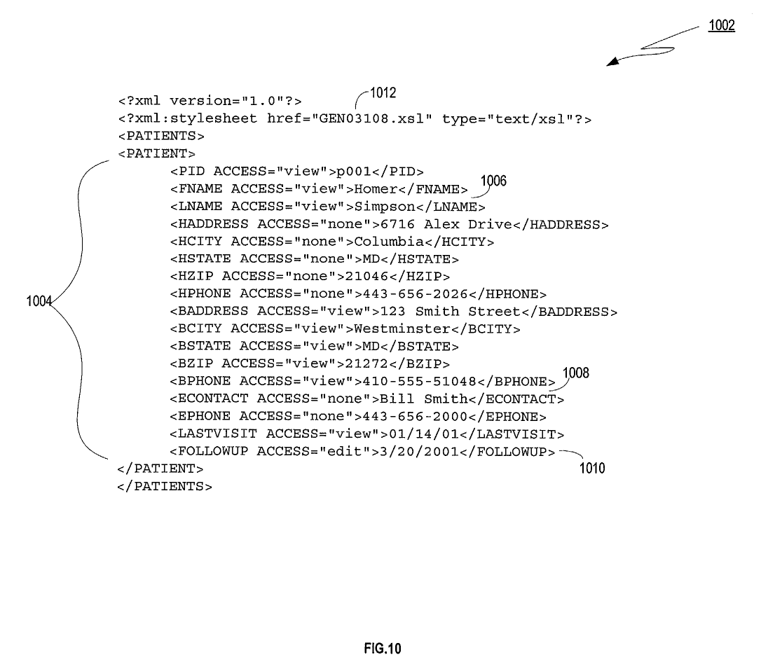

In this example, the semantic firewall is configured to perform the transformation for patient record content in three stages 510, 514 and 516. In the first stage of annotating, the semantic firewall accepts the patient record collection shown in FIG. 9 as input and applies rule-based transformations to produce the file shown in FIG. 10. Typically, this output is not actually rendered, but can be represented as a document object model (DOM) tree or series of SAX events in a transformation pipeline. Each field is marked with a new ACCESS attribute.

A rule used to transform the file in FIG. 9 is shown in FIG. 11. The rule is: a physician who is not the patient's own physician (e.g., another doctor at the hospital) is allowed to view billing address information and edit the follow-up visit date and time. In accordance with this rule, field 906 becomes field 1006, having an additional attribute of ‘access=“view”, meaning that the field is viewable by the user who is a physician. Similarly, field 908 becomes field 1008 and is viewable by the user; and field 910 becomes field 1010 having the attribute of being editable by the user. The date of the next follow-up visit is also incremented by approximately one month, taking into account holidays and weekends. The remaining fields in 904 are similarly processed based on the rules.

An example of a raw CLIPS rule, i.e. the textual computer program, used to create the file in FIG. 10 is shown in FIG. 11. The rule mentioned above is expressed as a CLIPS rule in the system and is used to guide the transformation process of the XML content produced by the NAS. A rule consists of conditions on the left-hand-side (LHS) of the “=>” symbol and actions on the right-hand-side (RHS) of the “=>” symbol. XML content is processed into a tuple space. If all conditions match on the LHS of a rule, the rule “fires”, and the actions on the RHS are performed. For example, lines 1104, 1106, 1108, and 1110 represent patterns within the condition of a rule (called rule6). Each pattern contains fixed content or variables. The elements NAME, POSITION and Physician in line 1106 are fixed, while the term “?ename” is a variable. Variables match any fixed content of a corresponding tuple in the tuple space (such as the tuple “(EMPLOYEES-EMPLOYEE (NAME Fred) (POSITION Physician))” from the XML content scanned into the system). Some variables can match none, one, or any number of terms in a tuple. For example, the variable $?rules in line 1110 matches the list of rules that are currently active. Named variables are bound to their values on the entire LHS of a rule. For example, if line 1104 matches the tuple “(SESSIONS-SESSION (NAME Fred))”, line 1106 must match the tuple “(EMPLOYEES-EMPLOYEE (NAME Fred) (POSITION Physician))” in the tuple space. If such a tuple does not exist, the entire rule fails to fire because it does not apply. Thus, the rule in FIG. 11 is interpreted as “for the current logged-in user whose name is ?ename (line 1104), and who is a Physician (line 1106), and not the patient's assigned physician (“˜?ename” means “NOT EQUAL to ?ename” in line 1108), and not yet under application of this rule (line 1110) (this rule cannot be applied more than once), set the ACCESS attribute to VIEW (line 1112) in the current patient for the fields PID, FNAME, LNAME, BADDRESS, BCITY, BSTATE, BZIP, BPHONE, and LASTVISIT (line 1114).” Line 1116 creates and stores the definition of rule6 in the rules for patients. Other rules (not shown) mark the ACCESS attribute to “none” or “edit” as their conditions dictate, while still other rules delete XML nodes during the transformation from FIG. 9 to the content in FIG. 10 such as INSURER, INSNUM, DOCTOR, VISITTIME, PURPOSE, SEENBY, and DIAGNOSIS.

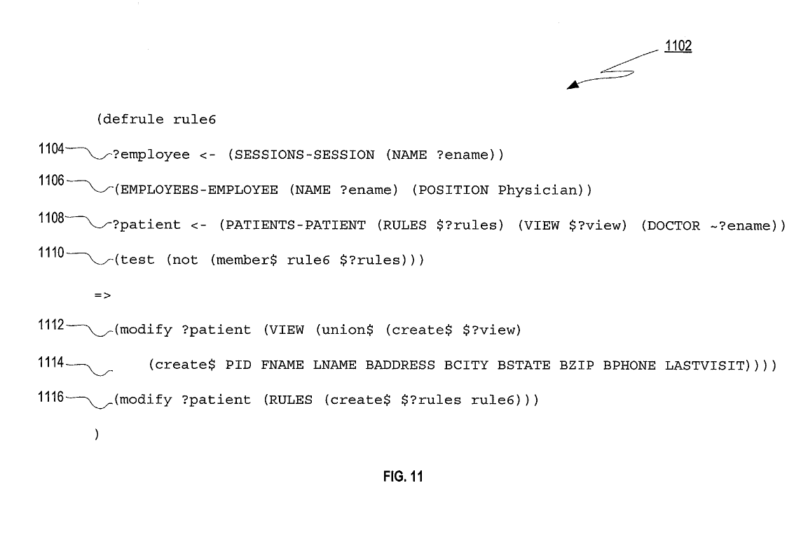

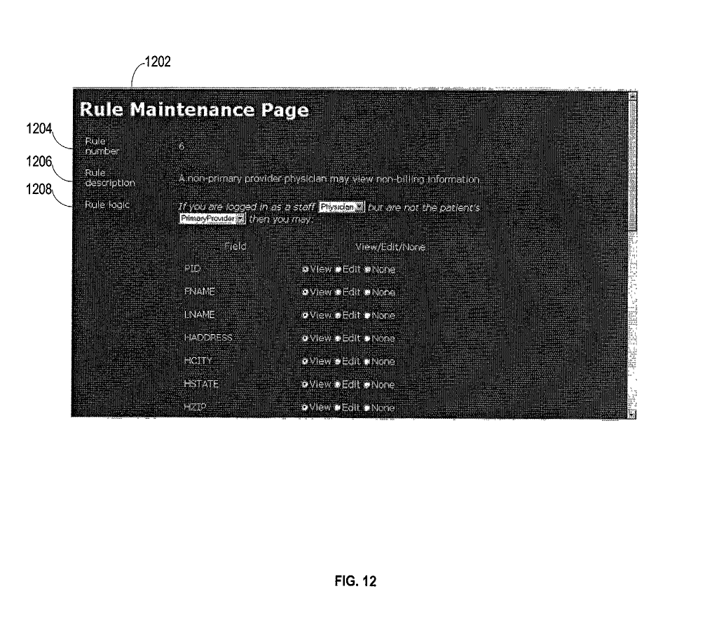

The rules themselves can be maintained and changed via an HTML form page such as the form shown in FIG. 12. The rule maintenance page 1202 shows the rule number 1204 and the rule description 1206. The rule setter, for example, a manager or a system administrator, can alter parameters of the rule logic 1208. For each field of data, the rule setter may choose rule attributes. In this example, the choices are whether the field is viewable, not viewable or editable. In this manner, a set of rules for a semantic firewall can be configured and managed by non-programmers without service interruption. The rule maintenance page itself can be automatically generated by the system, or written by the rule author.

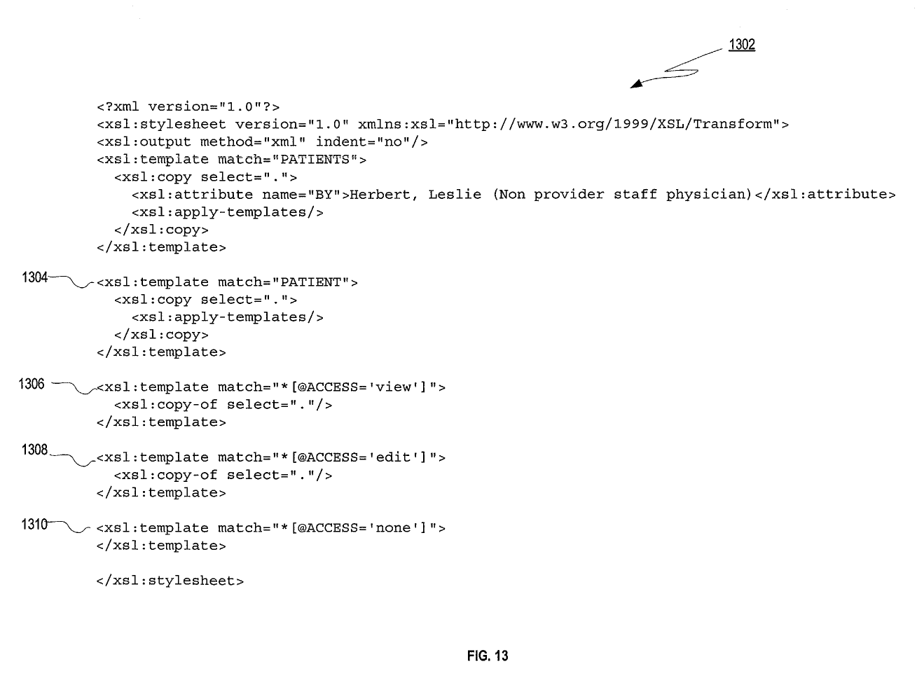

In the second stage of filtering by the semantic firewall 312 for this example, a style sheet 1302 as shown in FIG. 13 is produced dynamically. The style sheet is generated with information for the current user. This XSLT style sheet enforces the semantics of the newly added attributes by deleting certain fields from the XML content. For example, line 1304 copies all of a patient record. Line 1306 copies all fields with the ACCESS attribute equal to ‘view’. Similarly, line 1308 copies all fields with the ‘edit’ attribute. Line 1310 matches and deletes any field whose ACCESS attribute is equal to ‘none’ (meaning not viewable or editable), removing that field from the viewable data.

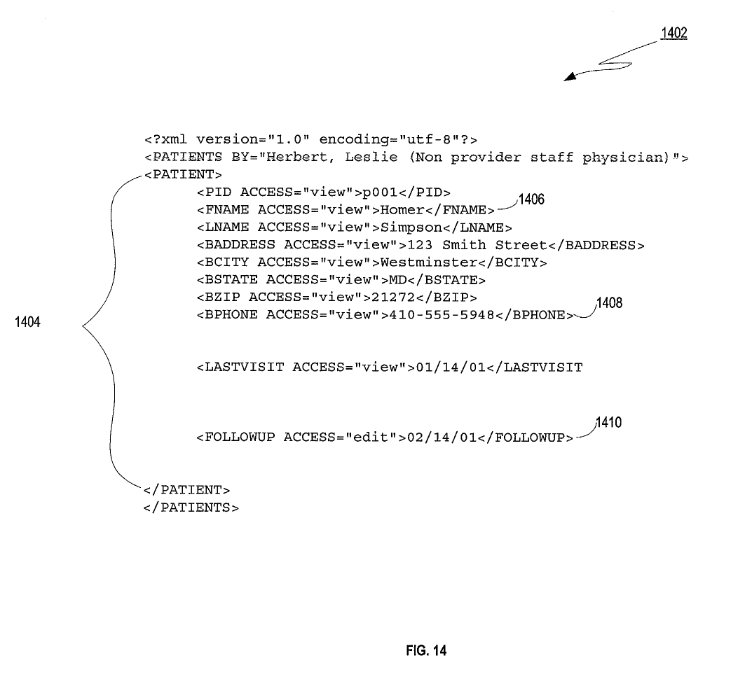

The result of applying the style sheet of FIG. 13 to the annotated file of FIG. 10 is shown in FIG. 14. In FIG. 14, only the viewable fields of the patient record 1404, such as 1406 and 1408, and editable fields, such as 1410, from FIG. 10 remain.

In the third stage of rendering by the semantic firewall 312 for this example, a static style sheet is applied to transform the final XML into HTML for presentation by the server or by a client, such as, for example, a user agent or browser. The style sheet can be applied by the semantic firewall, a redirecting server, or the browser itself. In the latter case, it proves valuable for the firewall to have eliminated XML content before sending the XML content to the browser. Eliminating the XML content before sending the XML content to the browser prevents secure data from being sent to the browser and intercepted before being filtered by the client transform. All filtering of secure information is best done on the server before sending it to the client.

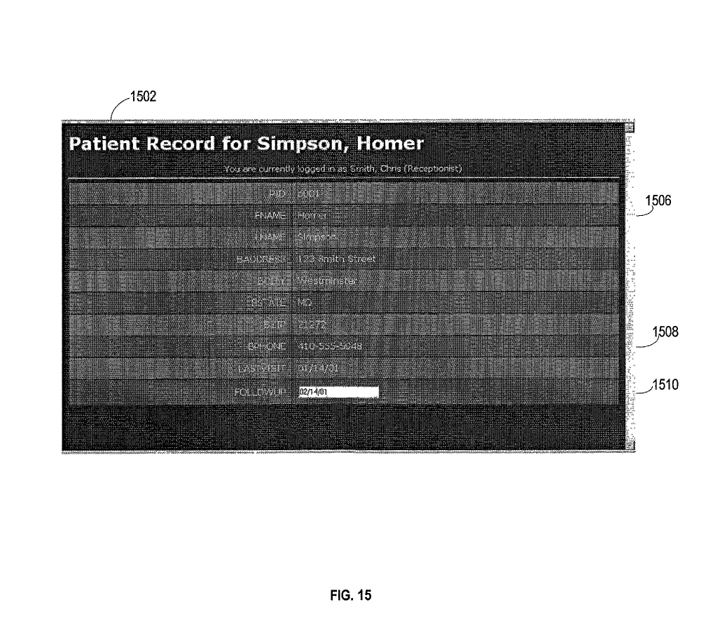

The rendered HTML is shown in FIG. 15, which shows a browser 1502 view of the file in FIG. 14. Fields 1506 and 1508, which correspond to the original fields 906 and 908, respectively, are viewable, but the user cannot modify the values. Only the last field 1510, “Followup”, which corresponds to original field 910, can be edited by the user.

For another exemplary embodiment employing a semantic firewall, consider the same medical ASP as in the previous example. In response to a SQL query from a physician such as:

“select id, status from patient_tests as xml”, the back-end database generates an XML fragment as output, as shown in FIG. 16. The fragment 1602 contains a series of records 1604, each having the ID 1606 and status 1608 of the patient from the patient tests. This output XML 1602 from the query is passed to the first stage as input.

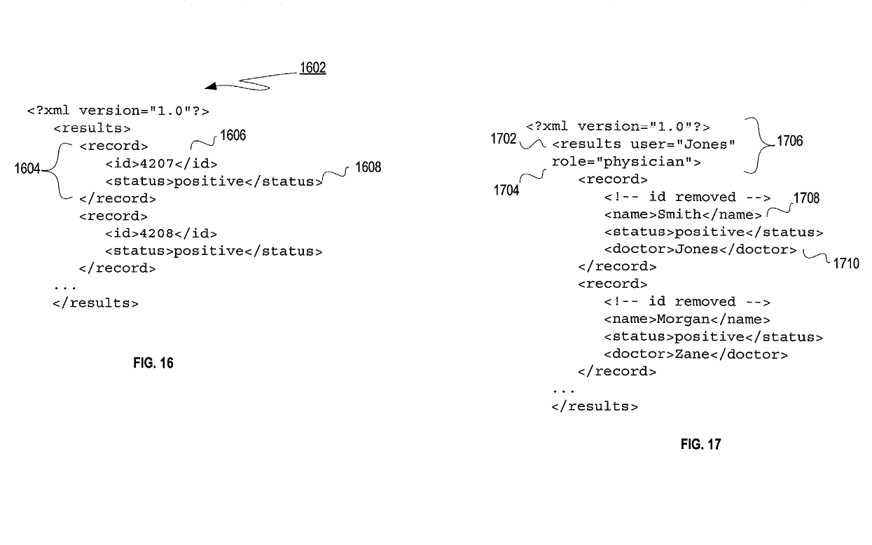

FIG. 17 shows the added session context information from the first stage, which, here, are the name 1702 and role 1704 of the current authenticated user making the request. The name 1702 and role 1704 are attributes in the top-level tag 1706. The first stage also transforms each record element by looking up the patient identifier in an LDAP database along with the name of the doctor of the patient. The ID tag 1606 is eliminated, and the name 1708 and doctor 1710 tags are added to produce the XML fragment in FIG. 17 as output from the first stage.

The XML fragment shown in FIG. 17 is passed as input to the second stage. The second stage applies complex security rules in order to transform the input by adding, deleting, or changing tags, attributes, nodes, and node content. In this example, the second stage adds a view attribute to each record to indicate which records should be shown or hidden by the next stage in the pipeline. The second stage adds the view attribute to the status tag of each record based on two rules: Rule 1—All physicians can see the list of patient records; Rule 2—Only the physician of the patient can view a medical test record for that patient.

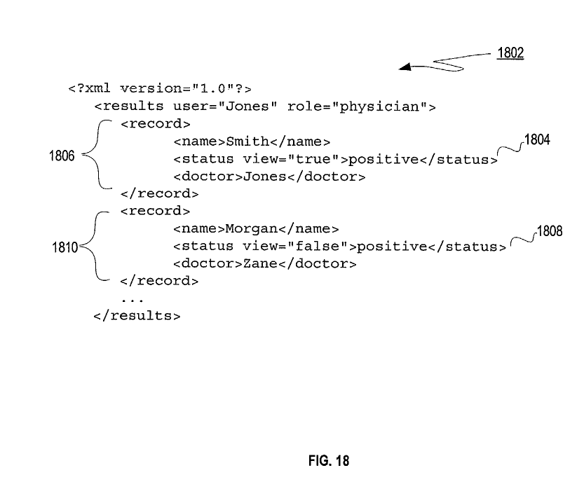

Based on these rules, the second stage produces the XML fragment 1802 shown in FIG. 18 as output. The status element 1804 of the first record 1806, the test result for Smith, can be viewed by the current user, Jones, because (1) Jones is a physician and can view all the records according to Rule 1, and (2) Jones is the physician for Smith in accord with Rule 2. The view attribute of the status element 1808 of the second record 1810, which is the test result for patient Morgan, is marked “false” because even though Jones is a physician, Jones is not the physician for Morgan.

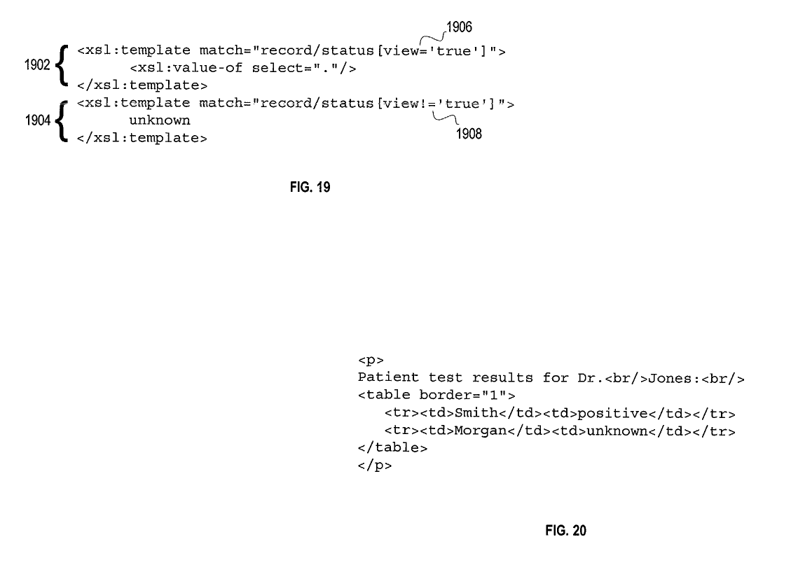

The XML fragment shown in FIG. 18 is passed as input to the third stage, where it is stylized based on the XML content produced as output from the second stage. The third stage uses an XSLT style sheet to transform the XML content into extensible hypertext markup language (XHTML). The XSLT style sheet uses the role attribute of the top-level tag, here “physician,” and the view attributes on the status elements to transform the XML content into the appropriate XHTML for presentation in the browser of a requesting client. The XSLT templates 1902 and 1904 shown in FIG. 19 are part of an XSLT style sheet used to transform the content as appropriate based on the view attributes 1906 and 1908 of the status element for each record.

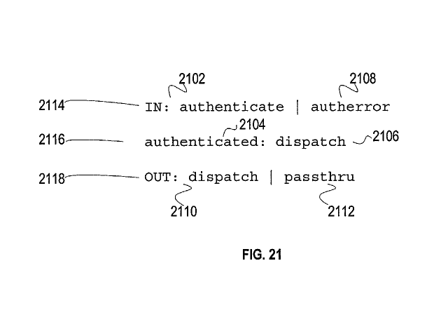

The fragment shown in FIG. 20 is exemplary final XHTML produced as output from the third stage. The resulting XHTML is sent to the requesting client in the body of an HTTP response. The third stage is implemented within the semantic firewall, which can be within a firewall server or implemented as a post-processing stage on a Web server. If the third stage is implemented as a post-processing stage, the stylization does not occur within the browser.

This example of a semantic firewall configuration illustrates the filtering of an outgoing XML response. Incoming XML documents and GET/POST variables can also be transformed by a series of filters within a semantic firewall. Elements of an HTTP GET or POST request (e.g., header and form elements) can easily be encoded within XML and filtered before query processing.

In an alternate embodiment, the style sheets do not depend on data content but rather on policy rules only. In the example presented above, the generated style sheet, in FIG. 13, for example, would be different for the different roles of the logged in user. The style sheets can be cached and regenerated on demand if needed. Likewise, fixed content from other backend systems (such as the roles of system users) can also be cached in the semantic firewall itself instead of being fetched and re-fetched for each filtering pipeline.

The semantic firewall is re-configurable in ways similar to traditional IP firewalls. However, filter chains enable non-programmers to compose pipelines of filters that are activated under various conditions. Similar to UNIX pipes and IP chains, filter chains can be composed together so that the output of one filter is connected to the input of another in a series using a terse configuration language. Unlike pipes and IP chains, however, filter chains can insert or retract conditions that activate other filter chains that can, in turn, redirect, clone, initiate or terminate chain activations. Whereas each filter can be implemented as a thread, each chain is also implemented as a thread of control in the semantic firewall process.

High-performance can be achieved through the use of caching, pre-parsing, pre-fetching, and primarily using a pipeline of SAX transformations. Transformation objects using the Transformation API for XML (TrAX) can be pipelined together to form a chain of transformations that feed events efficiently down a chain of tag handlers. With respect to FIG. 5, pipelining would eliminate transforming the output of a stage into XML and then back into an internal format between each stage. Instead, with pipelining, the output from a stage can be input directly into the next stage without having to transform the data. Similar to UNIX pipes, these transformers can be implemented as separate Java threads. Each thread does not have to wait until the previous thread in the pipeline completes.

For example, consider a set of three filter chains in which any incoming request must first be authenticated in order to be handled by any firewall filters. FIG. 21 shows an exemplary configuration file for the semantic firewall with three filter chains. The left-hand sides 2102, 2104, and 2110 of the filter chain rules 2114, 2116 and 2118, respectively, represent conditions and events, while the right-hand sides 2108, 2106, and 2112, respectively, of the filter chain rules represent a series of input-output filters. The first chain 2114 is triggered on any incoming HTTP request for any document type or URL. The authenticate filter 2102 is the first filter to be invoked. If the authentication is successful, the authenticated condition 2104 (i.e., event) is introduced. In the case of the OUT event 2110, the backend has produced content (in HTML, XML, etc.) to be processed by the semantic firewall. In this case, the HTTP response is dispatched to the appropriate filters (other filter chains not shown) or the content is simply passed through the identify filter (called ‘passthru’) 2112. This triggers the second filter chain 2116 to dispatch 2106, an HTTP request to the appropriate filters. If authentication fails at filter 2102, the failed authentication condition is piped to the “autherror” filter 2108. A chain can be terminated prematurely and introduce other conditions and events or proceed along the chain.

The inventive semantic firewall can be used in a number of applications and in different configurations, for example, for document routing and content management. Search engine technologies such as the JHU/APL HAIRCUT engine can be adapted to watch incoming and outgoing documents that pass through the semantic firewall. Incoming documents can be tagged and classified while outgoing documents can be annotated with links to related documents at the document, paragraph, and word levels.

The inventive semantic firewall can be used for enterprise form fill-in. The swiftID product of Sphere Software Corp. can be included in the semantic firewall to recognize web form field names automatically, translate the form field names into their semantic equivalents, and lookup profile information to fill-in form fields. Rules can be used to introduce state-dependent field contents and implement inter-field dependencies, for example, credit card and expiration date form fields for a transaction can change when either field is changed.

The inventive semantic firewall can be used as a Model 2 presentation paradigm. The semantic firewall can hold state information concerning the model-view-controller dependencies for backend application servers that have yet to implement the Model 2 paradigm. Holding the state information can enable migration of existing web applications towards the Model 2 approach.

The inventive semantic firewall can be used for encryption and authentication. The semantic firewall can be used to wrap an existing web site with an authentication shell as well as encrypt specific tags in XML content. Dynamically generated XSLT style sheets can introduce Javascript CDATA elements (via xsl:script elements) that can prompt the user for the private key passphrase of the user to decrypt a field.

The inventive semantic firewall can be used for a semantic wireless Web. The semantic firewall can be used to wrap a web site with rule-based transforms to VoiceML, WAP, and WML output using dynamically generated XSLT style sheets.

The inventive semantic firewall can be used in semantic auditing. Machine learning, neural network, and other artificial intelligence (AI) technologies can be used to watch XML content traffic at the tag level and log activities.

The inventive semantic firewall can be used for portal management. Portal sites provide an ability to customize page presentation to include news, discussions, and other content management capabilities to non-programmers. The semantic firewall can be used to allow authoring of rules directly to the end user. An end user can put together filter chains to improve the richness of the portal page behaviors on the portal page that the end user sets up.

The inventive semantic firewall can be used in legacy database integration. The semantic firewall can be used to wrap a plain, backend legacy database with a semantic firewall that generates simple object access protocol (SOAP) wrappers as an access point to the legacy system. Since SOAP implements remote procedure call (RPC) over HTTP, the semantic firewall filters the incoming SOAP requests and transforms the requests into database access calls.

The inventive semantic firewall can be used for address validation. For incoming HTTP POST requests, the meaning of a form field can be guessed, populated with existing data from previous transactions, and validated with ASP services such as, for example, Centris by Sagent. Incoming product registrations and other use data can be checked in the semantic firewall before accessing the backend database and web application server.

The inventive semantic firewall can be used as a financial firewall. The semantic firewall can filter, audit, and limit by amount or role and task access controls XML content with financial data. High-level rules can control access based on field specific data, client confidentiality, role-based permissions, and budget levels.

In an exemplary embodiment, the application server and semantic firewall can be implemented separately or in combination by one or more computer systems.

In an exemplary embodiment, the software to implement the application server and semantic firewall can be stored on one or more computer-readable media.

Although the current invention has been described with respect to XML data types. The invention can be implemented in other computer languages and can employ other data types.

The embodiments and examples discussed herein are non-limiting examples.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A system for processing data requests from clients via a network, comprising:
an application server coupled to said network, said application server providing content from a database to said clients via said network; and
a semantic firewall to pass and filter said content between said application server and said clients, said semantic firewall restricting access to a portion of said content for at least one client.

2. A system as in claim 1, wherein said semantic firewall annotates content from said database to obtain annotated data, filters said annotated data to obtain filtered data, and renders said filtered data to obtain rendered data.

3. A system as in claim 1, wherein said semantic firewall comprises:
means for annotating content from said database to obtain annotated data;
means for filtering said annotated data to obtain filtered data; and
means for rendering said filtered data to obtain rendered data;

4. A system as in claim 3, wherein said means for annotating employs at least one annotated scheme and a rule-based transformation to obtain said annotated data.

5. A system as in claim 3, wherein said means for filtering employs at least one rule and a rule engine to obtain said filtered data.

6. A system as in claim 3, wherein said means for rendering employs at least one static style sheet to obtain said rendered data.

7. A system as in claim 1, wherein said semantic firewall is exterior to said application server.

8. A system as in claim 1, wherein said semantic firewall is interior to said application server.

9. A method of processing a data request by a server, comprising the steps of:
receiving said data request from a client via a network;
retrieving requested data from a database;
annotating said requested data to obtain annotated data;
filtering said annotated data to obtain filtered data;
rendering said filtered data to obtain rendered data; and
providing said rendered data to said client via said network.

10. The method of claim 9, wherein the step of annotating comprises the steps of:
accessing a rules file, wherein said rules file defines rules for accessing data; and
annotating said requested data based on said rules in said rules file to obtain said annotated data.

11. The method of claim 9, wherein the step of filtering comprises the steps of:
creating a style sheet dynamically; and
applying said style sheet to said annotated data, thereby filtering said annotated data to obtain said filtered data.

12. The method of claim 9, wherein the step of rendering comprises the steps of:
accessing a static style sheet; and
applying said static style sheet to said filtered data, thereby generating said rendered data.

13. The method of claim 9, wherein said requested data is in extensible markup language (XML), and said rendered data is in hypertext markup language (HTML).

14. A computer system for performing the method of claim 9.

15. A computer-readable medium having software for performing the method of claim 9.
